(19) United States
(12) Patent Application Publication
(10) Pub. No.: US 2015/0338958 A1
(43) Pub. Date: Nov. 26, 2015

(54) MEASURING CIRCUIT FOR A CAPACITIVE TOUCH-SENSITIVE PANEL

(71) Applicant: Semtech Corporation, Camarillo, CA (US)

(72) Inventors: Robert DECARO, Camarillo, CA (US); Pascal MONNEY, San Diego, CA (US); Barry W. HEROLD, Escondido, CA (US)

(21) Appl. No.: 14/712,212

(22) Filed: May 14, 2015

Related U.S. Application Data
(60) Provisional application No. 62/000,748, filed on May 20, 2014.

(51) Int. Cl. G06F 3/044; G06F 1/32

(52) U.S. Cl. CPC G06F 3/044; G06F 1/3203; G06F 2203/04108

(57) ABSTRACT

A capacitive touch-sensitive panel, including a plurality of sense electrodes biased at a fixed voltage relative to a common guard electrode, and a measuring circuit comprising: a power management integrated circuit comprising a voltage source generating a modulation voltage that is available at a guard terminal of the power management integrated circuit that is in electric connection with the guard electrode, one or more slave integrated circuits, each connected to a plurality of sense electrodes and comprising a Capacity-to-Digital converter or a plurality of Capacity-to-Digital converters that are operatively arranged for generating digital measure codes representing the instantaneous electric capacity of sense electrodes; floating communication means allowing transfer of command, timing signals and/or measure codes between the master integrated circuit and said slave integrated circuits.

### REFERENCE DATA

The present application claims priority from U.S. provisional patent application 62/000,748 of May 20, 2014 in the name of Semtech Corporation, Camarillo, Calif., the contents whereof are hereby incorporated by reference in their entirety.

### FIELD OF THE INVENTION

The present invention relates to a parallel architecture for the readout of capacitive touch-sensitive panels and/or proximity detection.

### DESCRIPTION OF RELATED ART

Several techniques are available in the art for the measurement of capacitors, whereby said capacitors are used in proximity detection. Arrays of capacitive detectors are notably used in touch-sensitive displays, as employed in a multitude of portable devices.

One such technique is disclosed herewith in connection with FIG. 1 that illustrates a known technique for measuring a grounded capacitor Cin: it consists into varying the voltage of the capacitive electrode and detecting the corresponding charge variation across Cin. This is generally achieved by tying the capacitive electrode to the negative input (virtual ground) of a charge amplifier with a capacitor Cfb in feedback. The voltage variation on the input capacitor is achieved by applying a well-defined voltage variation on the positive input of the amplifier, as the negative input will track the positive one by feedback. Since the current across capacitor Cin may only flow towards Cfb (the amplifier having high impedance inputs), the charge variation across Cin (and thus the value itself of Cin) may be measured by measuring the voltage variation across feedback capacitor Cfb. This voltage variation can be measured directly in the analogue domain, processed, or converted into the digital domain. The circuit illustrated in FIG. 1 comprises, apart from the elements already mentioned, as well the readout circuit 120, an input capacitor to be detected 20, and a variable voltage source 80. In the present document, the variable voltage source 80 may be identified also as excitation voltage source 80, or varying voltage source 80, in equivalent manner, with the enumerated terms having the same meaning.

One drawback of this technique is its extreme sensitivity to any parasitic capacitor Cpar between electrode input node and ground, and in particular to the parasitic capacitors related to input pads, protections and parasitic capacitors of input amplifier, parasitic capacitors to supply voltages, and other disturbance sources. Indeed, these parasitic capacitors may not be distinguished from the capacitor to be measured and thus affect the measurement result.

Patent FR 2 756 048 describes techniques for measurement of a grounded capacitor, as typically used for proximity detection. The advantage of these techniques lies in their precision and in that, they are quite insensitive to parasitic capacitors. This is achieved by varying with respect to ground not only the voltage of the capacitive electrode, but also all the voltages of the measuring circuitry. All the voltages vary in the same way as the voltage of the capacitive electrode such that the voltage across the parasitic capacitors does not change. To this end, all the input circuit or charge amplifier is referred to a local reference potential, also named a local ground (typically the substrate of the measurement circuit), which is caused to vary with respect to the global ground by some excitation circuit, such the voltage source that generates the varying voltage Vin, as shown in FIG. 2. As it may be seen from that figure, the local ground (floating voltage VF) is floated with respect to the global (external) ground. The readout circuit is supplied by floating positive and negative supplies that are referenced to local ground. From measurement circuit point of view, “only” the external ground voltage is changing, all the internal circuitry being referred to floating voltage. Hence, the measurement is insensitive to parasitic internal capacitors. The circuit illustrated in FIG. 2 comprises in addition to the elements already mentioned above and in connection with FIG. 1, a floating domain 170 and a floating supply and ground 175.

The capacitor Cin to be measured may be far from the measurement circuitry, however, so any parasitic capacitor between the wire connecting Cin to measurement circuit and ground, would be added to the measured capacitor. To avoid this error, the wire connecting Cin to the measurement circuitry may be uncoupled from the external ground by using a guard electrode. This guard electrode must then be connected to the internal or floating ground VF or to a node biased at a constant voltage with respect to VF, such that the capacitor between capacitive electrode and guard remain biased at a constant voltage and does not affect the measurement result. For this reason, the measurement circuitry has a guard output tied to internal ground VF or biased at a constant voltage with respect to it, and the guard of the wire between capacitor and measurement circuit should be tied to this output of the measurement circuit, as illustrated in FIG. 3. The circuit illustrated in FIG. 3 comprises in addition to the elements already mentioned above and in connection with FIGS. 1 and 2, a guard 30 and the floating voltage VF is indicated with numeral 85.

### BRIEF SUMMARY OF THE INVENTION

According to the invention, these aims are achieved by means of the object of the appended claims.

### BRIEF DESCRIPTION OF THE DRAWINGS

The invention will be better understood with the aid of the description of an embodiment given by way of example and illustrated by the figures, in which:

FIGS. 1 to 3 show, schematically, known circuits used in capacity measurements.

FIG. 4 illustrates a LCD panel overlaid by a transparent guard electrode, above which are placed a plurality of conductive transparent pixels, and a part of a capacity measuring apparatus according to the invention.

FIG. 5 shows the building blocks of a possible embodiment of the present invention.

FIG. 6 shows a measuring system involving a capacitive-sensitive chip in which the guard generator has a three-state output that foresees a high-impedance state.

FIGS. 7a and 7b illustrate an application of the circuit of FIG. 6.

FIG. 8 illustrates an embodiment of the invention that includes a chip acting as master chip and a plurality of similar chips acting as slave chips.

FIG. 9 illustrates an embodiment of the present invention including a specialized master chip that manages the guard supply, and several slave chips responsible for the pixel readout.

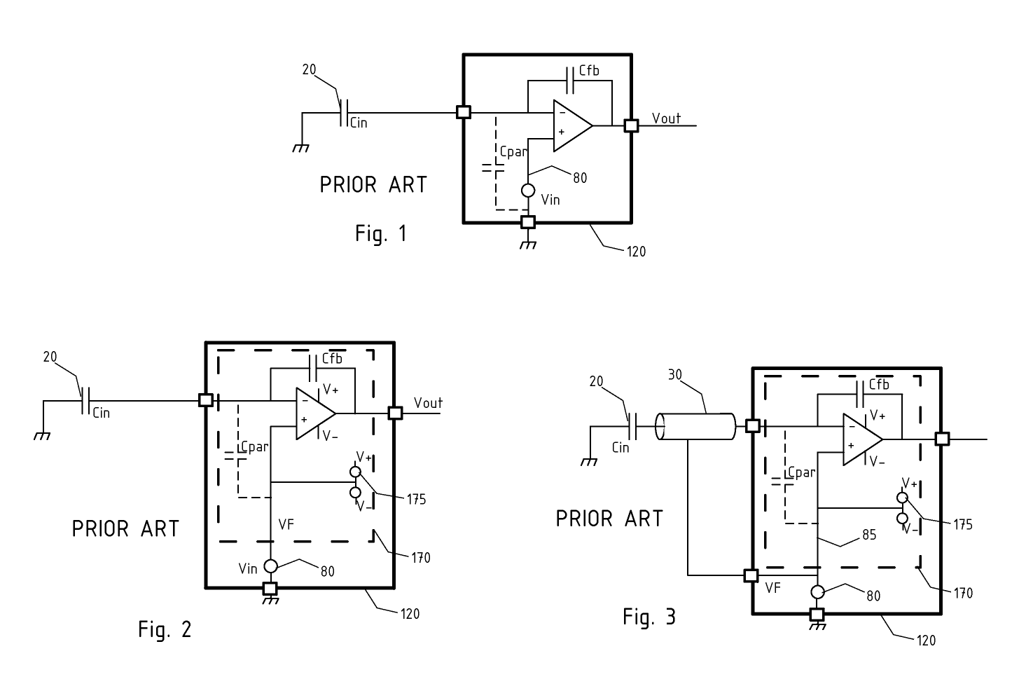

### DETAILED DESCRIPTION OF POSSIBLE EMBODIMENTS OF THE INVENTION

In a display application, typically for smartphones or tablets, the capacitive electrodes are placed on top of an LCD display and the capacitances to be measured are between these top electrodes and external ground, through the finger approaching the screen.

However, only the capacitance on the upper side, with respect to fingers, is of interest, while the capacitance with respect to LCD and parasitic signals from LCD is not useful to detect finger's proximity and, indeed, the activity of the LCD is liable to inject unwanted charges in the readout circuit through the parasitic capacitors, which could false the output of the proximity detector. For this reason, a conducting guard layer is inserted between the capacitive electrodes and the LCD display. This conducting guard layer should also be tied to the guard output of the measurement circuitry, as for the guard of the wires between touch screen and measurement circuitry.

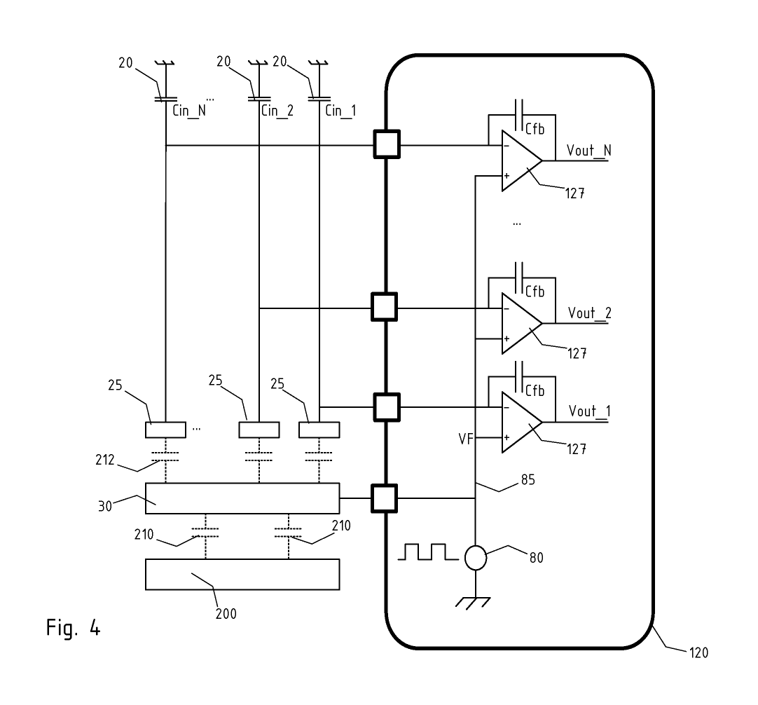

Such an arrangement is exemplified in FIG. 4 in which a LCD panel 200 is overlaid by a transparent guard electrode 30, above which are placed a plurality of conductive transparent pixels 25 that are connected to a plurality of Capacity-to Digital Converter included in a readout circuit 120. Each CDC 127 includes a charge amplifier. Since the guard electrode can be regarded as an equipotential surface, it provides an effective electrostatic screen, and unwanted interferences that may come from the LCD 200 are effectively screened by the guard potential and do not reach the CDC stages 127.

As discussed above, the readout circuit includes a variable voltage source 80 that generates a reference potential 85 that is connected to the guard potential 310 and to the non-inverting inputs of the charge amplifiers 127 of the CDC. In this configuration, the CDC stages have low-impedance virtual ground inputs, and the pixel electrodes 25 are essentially held at the potential 85 of the guard electrode 30. The amplitude of the signal at the outputs Vout_1, Vout_2, Vout_N is proportional to the respective capacities towards ground Cin_1, Cin_{—}2, . . . , Cin_N, seen by the electrodes 25. Importantly, the voltage across parasitic capacitors 212, which are connected between the guard electrode 30 and the pixels 25 is constant, hence these parasitic elements do not contribute to the readout.

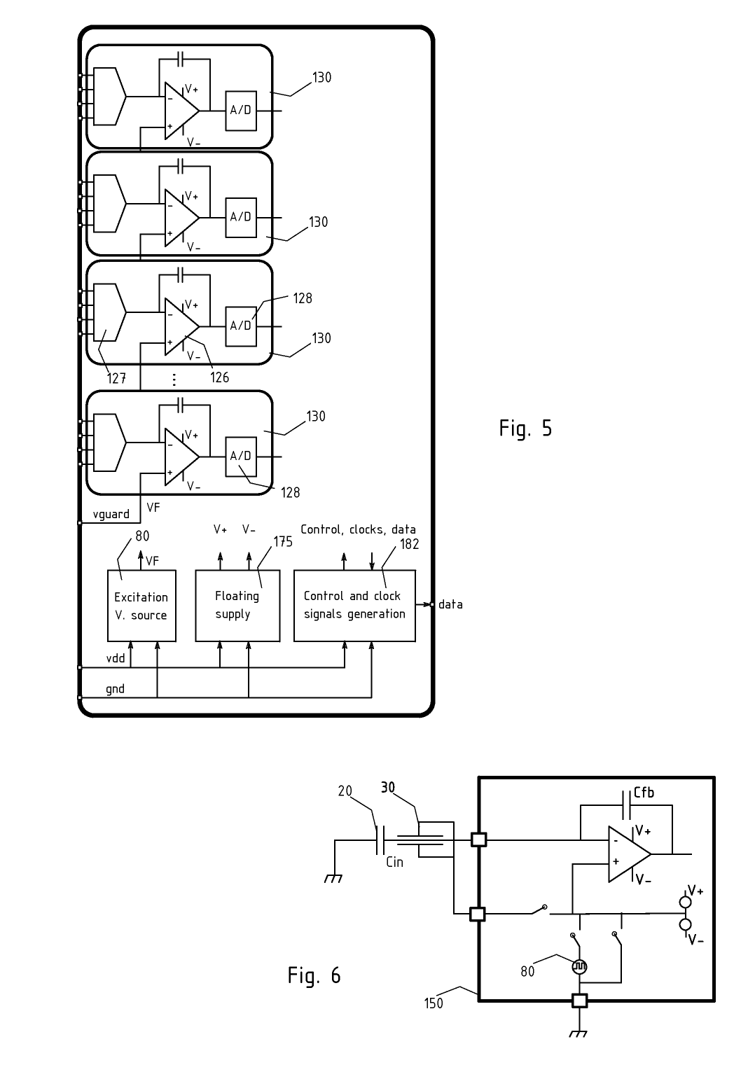

The circuit for measuring the external grounded capacitor thus includes several building blocks, represented in FIG. 5:
The excitation voltage source 80, used to generate the floating node VF, or local ground, varying with respect to the global or external ground.
The acquisition and measurement circuitry for measuring the charge variation across the capacitor to be measured, which produces a signal or, preferably, a digital code that represents this capacity. Dependent on the number of capacitive input pixels this circuitry may include a plurality of independent capacity-to-digital converters 130, each referred to floating ground VF. The converters 130 may comprise a charge amplifier 126 (amplifier with feedback capacitor tied between output and negative input, and with positive input tied to the floating ground) and eventually other circuitry for post processing, such as analogue to digital converters 128, filters, amplifiers, attenuators, or input multiplexers 127.
Generation of the supply voltages (V+, V−): since the converters 130 are referred to the floating ground, their active elements should preferably be alimented with voltage sources that are referenced to the floating ground rather than to the external ground. The floating supply unit 175 produces the required alimentations, from an external voltage supply vdd referred to external ground. The floating supply 175 may include inductive transformers, DC/DC converters of the boost or buck variety, switched-capacitor circuits, or any other voltage conversion scheme.
Generation of control and clock signals 182: many functions of the acquisition circuits need to be synchronised with the modulation signal applied between external ground and internal or floating ground. In particular, the detection of the charge must be perfectly synchronous with the modulation signal. Moreover, data coming from the acquisition units 130 need to be transmitted outside of the floating voltage domain.

In many applications, and particularly where touch screen and proximity detections are concerned, a large number of capacitors must be measured simultaneously or successively. The measurement circuitry may then include several acquisition chains or acquisition circuitry 130 in parallel for measuring a large number of capacitors. A multiplexer 127 may be added in front of each measurement circuitry in order to address successively different input electrodes, one after the other, as illustrated in FIG. 5. The multiplexers in front of the acquisition chains allows addressing several inputs in succession by each acquisition chain, thereby reducing the number of acquisition chains to implement on a chip.

There is however a physical limit to the number of capacitive inputs that can be addressed by a single chip. For practical reasons, there is a minimum pitch between two consecutive input pads, and the physical size of the chip cannot exceed certain limits determined by the nature of the process used, thermal expansion, and other constraints. When the number of capacitive cells on the display exceeds the number of inputs that can be tied to a single chip, several chips must be used to address them all.

Theoretically, the different chips could measure their corresponding input capacitors in parallel fashion and independently from one another. This is however hardly possible in the case of a display that is read with the scheme illustrated in FIG. 4, having a guard electrode common to all the input pixels. Indeed, each measurement circuitry forces a varying signal on the guard voltage, and these signals must be synchronized with the control signals for the acquisition chains. Thus, should several chips try to drive the guard electrode independently, their output would conflict, the resulting guard voltage could not be controlled properly, and it would not be synchronised with the acquisition chains.

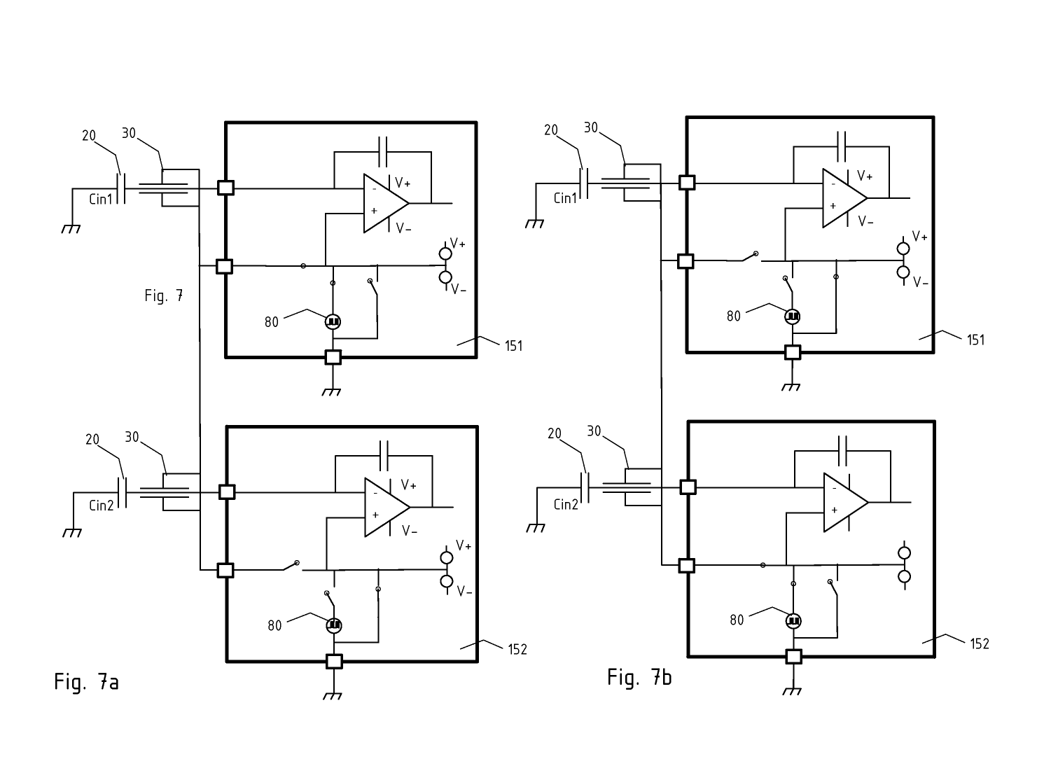

A possible solution to this state of affairs, named “tandem arrangement” is based on a tri-state output for the guard, as illustrated in FIG. 6. The different chips (typically 2) are active successively, one at a time, the guard being driven only by the chip, which is actively measuring, while the other inputs are in a high-impedance state. By this arrangement, any conflict on the guard is avoided. The two (or more) chips working in tandem are controlled by a host processor, which activates them one at a time. The solution is depicted in FIGS. 7a and 7b for the case of two chips working in tandem. FIG. 7a shows the configuration in which the guard potential is determined by the upper circuit 151 that is reading his input capacitor 20, while the lower circuit 152 is in an inactive, high-impedance state; FIG. 7b illustrates the situation in which the roles of upper and lower circuits 151, 152 are exchanged.

This variant, albeit functional, has the limitation that, as all chips must acquire their capacitive inputs one after the other the achievable frame rate is limited by the number of chips. Moreover switching from one chip to another is a time-costly operation. When a chip becomes inactive, it is put in a sleep mode in order to reduce its power consumption. When it becomes active, considerable time may be lost to wake it up.

According to another variant of the invention, the readout circuit of the invention comprises a power management (or master) chip that drives the guard at all times, and a plurality of slave chips measuring the capacitors in parallel. Different solutions are possible, but in any case, the measuring chips must be perfectly synchronized with the power management chip. Preferably, the master chip generating the guard provides timing information to all the slave chips, such that they can synchronize to the master.

According to a possible variant of the invention, the readout comprises several identical chips having an organization similar to that represented in FIG. 5 in order to address all the capacitors of the display. Each chip includes one or several acquisition chains and the necessary hardware to generate the guard voltage and the floating supply voltages. Only one of those circuit is configured as master, however, and drives the guard (floating ground), together with the floating supply voltages. The other chips are slaves: they rely on the guard voltage and floating supply that are provided by the master rather than generating their own. The configuration of the chips as master or slaves can be done for instance by an external input pin tied to vdd or gnd, by addressing a memory location, by writing a predetermined value in a register, or in any other suitable way.

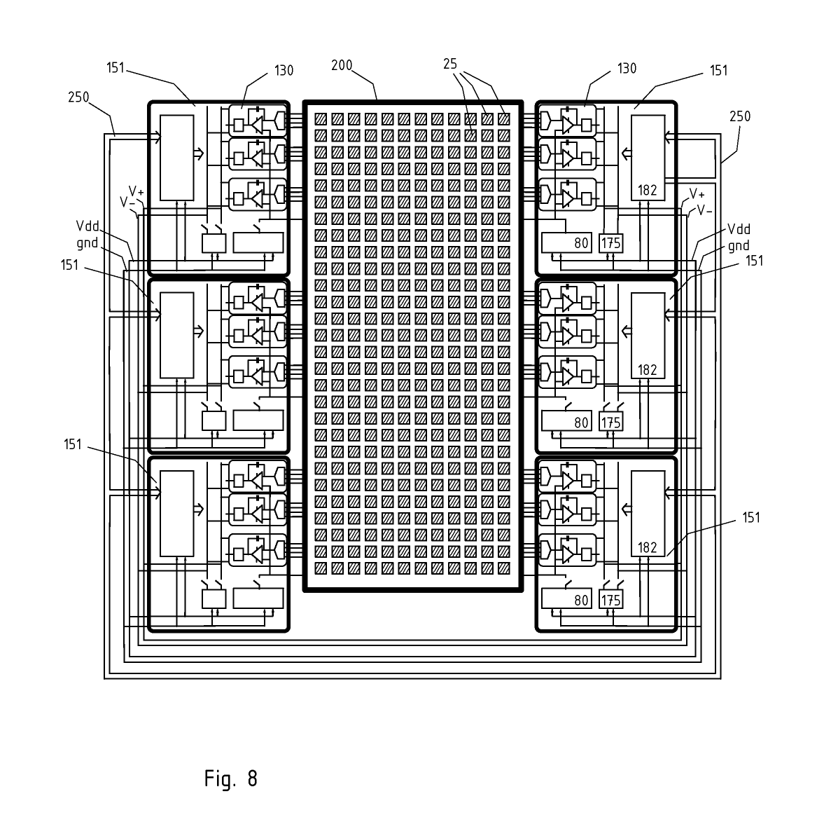

The guard voltage generated by the master chip is tied to the display, but also to all the other chips, and determine the potential of the positive input of the respective charge amplifiers, or in other words, the voltage of the virtual grounds seen at their inputs. Preferably, the chip configured as master also provides clock, control and synchronization to all the other chips, through a digital bus. This solution is shown at FIG. 8, which shows six chips 151, each of which being capable of functioning as a master or as a slave, connected to a capacitive touch-sensitive array 200 that carries a grid of capacitive sense pixels 25, and a common guard electrode, not visible. One of the chips 151, for example the one at the top right corner, is designed and configured as a master, generating the guard voltage and the floating supply voltages V+ and V− and providing the clock, control and synchronization signals to all the other chips through the bus 250.

The remaining chips 151 in FIG. 8 are designated and programmed to operate as slaves: the guard voltage sources 80 and the floating supply generators 175 are inactive and their output are set in a high-impedance state, such that these voltages are generated by the master chip for all the chips 151 connected to the capacitive touch-sensitive array 200.

Notice that the master chip may also provide other functions or signals, either analogue or digital, to the other chips, such as reference voltages, or calibration signals (not shown on FIG. 8). The master chip can also optionally (not shown on FIG. 8) collect data from the other chips, such as the measurement results, in order to centralize them towards a host processor. Also all the chips may interface with a host processor (still not shown on the figure) either directly or through the master chip, in order to get configuration data and commands and send back measured data. In such a scenario, the commands can however be interpreted differently for the master chip than for the slave chips.

The advantage of the solution described above and illustrated at FIG. 8 is that it can be implemented with only one type of chip, two instances of the same chip can be operated as a master and a slave. In the drawing, this is represented by the switches that are open in the slave units, and closed in the master one, such that, in the former ones, the modulation source 80 and the floating supply unit 175 are inoperative, while in the latter they determine the floating ground and provide supply for all the chips connected to the LCD panel 200. The drawback of this solution is that for most of the chips (all the slaves), several functions (generation of guard voltage, and of floating supply voltages, clock generations . . . ) are not used, meaning inefficient use of silicon area and increased costs. In the slave chips, only the acquisition chains 130 are used for measurement of the capacitive electrodes.

According to a possible variant, when several chips are required to address all the capacitive electrodes of the display, the touch sensitive panel is read by two different types of chips, namely: a PMS chip (Power Management & synchro) acting as master chip, driving the guard (floating ground) and the floating supplies. This chip acts as the master. It also provides the clock, control and synchronization to all the other chips, plus eventually also other functions such as reference voltages, calibration; and an AFE (Analog Front End) chip, acting as slave containing only the acquisition chain in order to measure the capacitive inputs (charge amplifiers, and A/D converters basically).

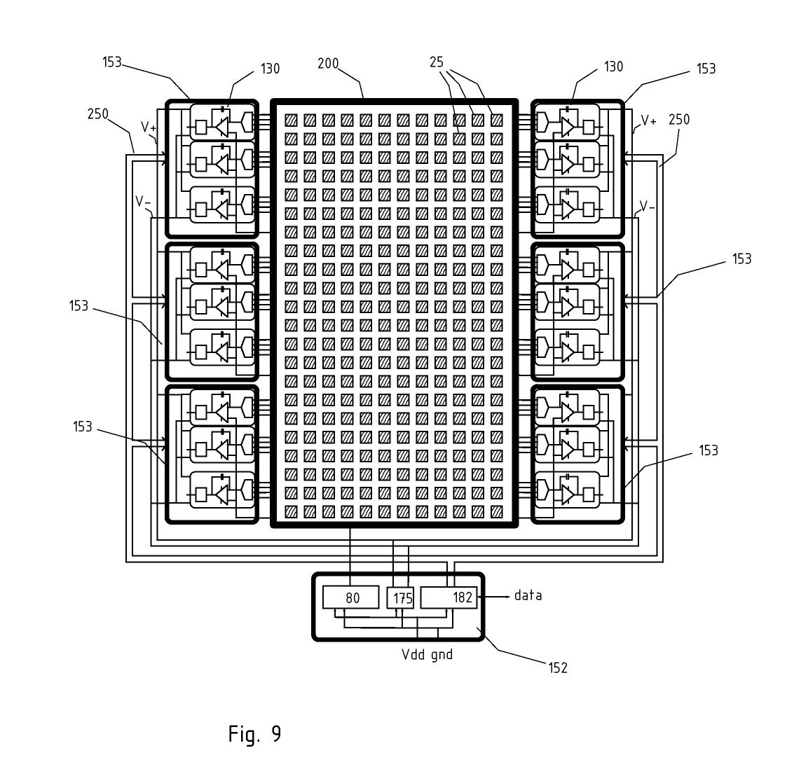

This variant is represented in FIG. 9, with the display being interfaced by 6 AFE slave chips 153 and one PMS 152 controlling them and managing the guard and generating the floating supplies V+ and V−.

Although the chip count in solution of FIG. 9 is higher, the individual chips are simpler and function duplication is avoided. This separation of tasks between a power management master and slave chips might be desirable also because, in some cases, the slave chips 153 may be realized with a simpler process than the master 152, and would therefore be less expensive. For example, the master chip could be realized by a HV or insulated well process, in order to manage different zones having different reference voltages, while the slave chip, that are essentially entirely floating over the guard potential, could be obtained by a simpler LV process.

By means of multiplexing the input pixels, each slave circuit can read up to 128 pixels per IC, on 16 CDC stages, each 8× multiplexed. By using 6 slaves, the measuring circuit of the invention can read up to 768 pixels, which would be adequate for a tablet screen, but the same architecture could be usefully employed, with only two slaves, for reading a cellphone tactile screen having only 256 pixels.

Optionally the master chip 152 (PMS) could also include itself an acquisition chain 130 that would act as an in-chip slave and read the capacity of a subset of the touch-sensitive pixels 25, thus bringing the chip-count down to the same number as in the architecture of FIG. 8.

The different AFE's (slaves) may send their data to either directly to the host processor, or back to the master, which centralizes them. In this case, only the PMS (master) need to interface with the host processor.

Importantly, the power supply and all the floating ground references that need to carry substantial currents are physically separate from the guard electrode, in this way avoiding measurement errors. Should the slave chips need access to the absolute value of the guard potential, for example for timing purposes, this should preferably be carried by a different track or connection than what is used to polarize the guard electrode, if possible a buffered one.

Preferably, slave chips and master chips communicate together by a suitable floating communication means or data bus, for exchanging instruction, synchronisation information configurations to the slave from the master, and also the capacity readout from the slave chip to master power management chip that has the function, as mentioned above of providing a single centralized access point for the host processor. The required independence from the ground level could be obtained by using a differential protocol, but other communication methods could also be employed, in the frame of the invention.

In a preferred variant, a plurality of slave chips are connected to one common multipoint differential low-voltage bus, in order to limit the interconnection count. The differential signal is used for the bidirectional data exchange between the slaves and the master, independently form the respective ground levels. In a possible variant, the common-mode voltage of the differential bus transmits to the slave chips an information on the absolute guard potential.

### REFERENCE NUMBERS

20 Input capacitor to be detected
25 capacitive sense electrodes
30 guard
80 varying voltage
85 floating potential
120 Measurement circuitry
126 multiplexer
127 charge amplifier
128 ADC
130 acquisition chains
150 chip
170 Floating domain
175 Floating supply & ground
182 control and clock signals
200 LCD, capacitive touch-sensitive array
210 parasitic capacitances
250 bus
151 master/slave chip
152 PMS master chip
153 AFE slave chip

1. A measuring circuit connectable to a capacitive touch-sensitive panel, the panel including a plurality of sense electrodes and a common guard electrode, the circuit being adapted to measure variations in the instantaneous electric capacity of the sense electrodes in response to proximity to conductive bodies, wherein the sense electrodes are biased at a fixed voltage relative to the common guard electrode, the measuring circuit comprising:
a power management integrated circuit comprising a voltage source generating a modulation voltage that is available at a guard terminal of the power management integrated circuit that is in electric connection with the guard electrode,
one or more slave integrated circuits, each connected to a plurality of sense electrodes and comprising a Capacity-to-Digital converter or a plurality of Capacity-to-Digital converters that are operatively arranged for generating digital measure codes representing the instantaneous electric capacity of sense electrodes;
floating communication means allowing transfer of commands, timing signals and/or measure codes between the master integrated circuit and said slave integrated circuits.

2. The measuring circuit of claim 1, further comprising one or more floating power supply for the supply of the slave integrated circuits.

3. The measuring circuit of claim 1, further comprising one or more floating voltage references for the Capacity-to-Digital converters of the slave integrated circuits.

4. The measuring circuit of claim 2, wherein said floating power supply and/or said floating voltage references are included in said power management integrated circuits.

5. The measuring circuit of claim 2, wherein said floating power supply is included in said power management integrated circuit and comprises a floating ground terminal that is at the same electric potential as said modulation voltage, and is in electric connection with ground terminals of said slave integrated circuits by means of a conductive path that is physically distinct from the connection between the guard terminal of the power management circuit and the guard electrode.

6. The measuring circuit of claim 1, wherein said power management integrated circuit is produced by means of an isolated wells process, and said slave circuits are produced by a standard LV process.

7. The measuring circuit of claim 1, wherein each slave circuit includes a plurality of CDC stages.

8. The measuring circuit of claim 1, wherein the slave integrated circuits include an input multiplexer between input terminals connected to the sense electrodes and in said Capacity-to-Digital converter or said plurality of Capacity-to-Digital converters.

9. The measuring circuit of claim 1, wherein the sense electrodes are individually addressed and their capacities are individually measured.

10. The measuring circuit of claim 1, wherein said capacity-to-digital converters have a sensitivity better than 100 aF rms.

11. The measuring circuit of claim 1, wherein said power management integrated circuit and said slave integrated circuits are identical.
